(19) United States
(12) Patent Application Publication
(10) Pub. No.: US 2024/0279022 A1
(43) Pub. Date: Aug. 22, 2024

(54) CABLE TENSIONING BASED ON LOAD PROFILES

(71) Applicant: Rivian IP Holdings, LLC, Plymouth, MI (US)

(72) Inventors: Michael Rosenblatt, Boulder, CO (US); Jeffrey Wei Doong, Redondo Beach, CA (US)

(21) Appl. No.: 18/170,181

(22) Filed: Feb. 16, 2023

(51) Int. Cl. B65H 49/34

(52) U.S. Cl. CPC B65H 49/34; B65H 2515/31; B65H 2701/34

(57) ABSTRACT

Cable tensioning based on load profiles is provided. A system can include a dispenser of a charger and one or more processors. The system can detect a characteristic of a vehicle. The system can determine, based at least in part on the characteristic of the vehicle, an amount of force to apply to a cable. The system can provide an instruction to cause the dispenser to apply the amount of force to the cable.

### INTRODUCTION

Chargers can deliver power to a vehicle via a cable.

### SUMMARY

This disclosure is generally directed to adjusting or setting the amount of tension applied to a cable used to deliver power between a charger and a vehicle. The amount of tension applied to the cable can be adjusted or set based on a characteristic of the vehicle. For example, different vehicles may use different lengths of cable and different cable load profiles based on how the vehicle is oriented relative to the charger and the location of the charger on the vehicle. To reduce pull force on the cable, this technical solution can generate or use one or more load profiles that maps the amount of tension to apply to an angle and length of the cable. For example, the technology can formulate a tension vs. angle vs. length profile to determine a load profile based on the detected/identified vehicle. Thus, this technical solution can adjust the load profile used to dispense a cable from an electric vehicle charger based on detected characteristics of the vehicle to be charged.

At least one aspect is directed to a system. The system can include a dispenser of a vehicle charger. The dispenser can be configured to provide a cable. The system can include one or more processors communicatively coupled with memory and the dispenser. The one or more processors can be configured to detect a characteristic of a vehicle. The one or more processors can be configured to determine, based at least in part on the characteristic of the vehicle, an amount of force to apply to the cable. The one or more processors can be configured to provide an instruction to cause the dispenser to apply the amount of force to the cable.

At least one aspect is directed to a method. The method can include detecting, by one or more processors coupled with memory, a characteristic of a vehicle. The method can include determining, by the one or more processors based at least in part on the characteristic of the vehicle, an amount of force to apply to a cable. The method can include providing, by the one or more processors, an instruction to cause a dispenser to apply the amount of force to the cable.

At least one aspect is directed to a vehicle charger. The vehicle charger can include a dispenser configured to provide a cable. The vehicle charger can include one or more processors communicatively coupled with memory and the dispenser. The one or more processors can be configured to detect a characteristic of a vehicle. The one or more processors can be configured to determine, based at least in part on the characteristic of the vehicle, an amount of force to apply to the cable. The one or more processors can be configured to provide an instruction to cause the dispenser to apply the amount of force to the cable.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system to control a cable of a charger.

FIG. 2 depicts an example method for controlling cables of a charger.

FIG. 3 depicts an example method for applying tension to a cable.

FIG. 4 depicts an example vehicle and a charger.

FIG. 5 is a block diagram illustrating an architecture for a computer system that can be employed to implement elements of the systems and methods described and illustrated herein, including, for example, the systems depicted in FIG. 1 and FIG. 4, and the methods depicted in FIG. 2 and FIG. 3.

### DETAILED DESCRIPTION

Following below are more detailed descriptions of various concepts related to, and implementations of, methods, apparatuses, and systems of applying tension to a cable based on a load profile. The various concepts introduced above and discussed in greater detail below may be implemented in any of numerous ways.

The present disclosure is directed to systems and methods of adjusting or setting the amount of tension applied to a cable based on a characteristic of the vehicle. The system can include devices and methods for detecting a characteristic of a vehicle and providing a corresponding tension or force to a cable of a vehicle charger. In this manner, the cable of the charger can be withdrawn from the vehicle charger for connection to the vehicle in an efficient manner while improving the longevity of the cable.

Different types of vehicles can be connected to a charging station. Vehicles can be a different height, have a different location of charge port, or can approach the charging station in different orientations. As a result, different configurations of charging stations may be used. For example, different vehicles may use different lengths of cable and different cable load profiles based on how the vehicle is oriented relative to the charger and the location of the charger on the vehicle. This can result in different pull forces and difficult maneuvering of a heavy cable. This maneuvering can reduce the life span of the cable as well as make it difficult for a user to charge a vehicle.

To reduce pull force on the cable, this technical solution can formulate a load profile (e.g., a tension vs. angle vs. length profile) based on the type of vehicle and the orientation of the vehicle relative to the charger. Thus, this technical solution can adjust the load profile used to dispense a cable from an electric vehicle charger based on detected characteristics of the vehicle to be charged.

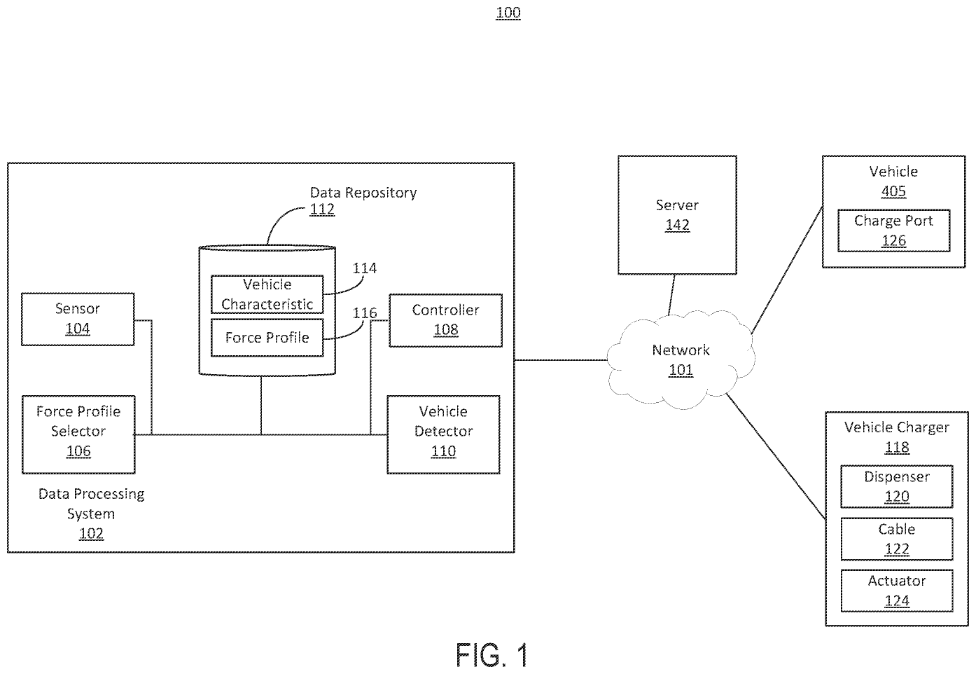

FIG. 1 depicts an example system 100 to control a cable of a charger. Controlling a cable can include detecting a vehicle, selecting a force profile, and controlling the cables of the vehicle charger based on at least upon the force profile. The system 100 can include a data processing system 102. The data processing system 102 can include one or more sensors 104, a load profile selector 106, a controller 108, a vehicle detector 110, or a data repository 112 including one or more vehicle characteristics 114 and force profiles 116. The system 100 can include, interface, access or otherwise communicate with a server 142, a network 101, a vehicle 405 including a charge port 126, or a vehicle charger 118 including a dispenser 120, a cable 122, and an actuator 124. The sensor 104, load profile selector 106, controller 108, vehicle detector 110, server 142, or network 101 can each communicate with the data repository 112.

The data repository 112 can be any memory, storage, or cache for storing information or data structures that facilitates the data processing system 102 to apply tension to a cable. The data repository 112 can contain any information about the system 100 and can allow that information to be accessed by any components of the data processing system 102, such as by communication methods described herein. The data repository 112 can contain at least vehicle characteristics 114 and force profiles 116. The information or data structures (e.g., tables, lists, or spreadsheets) contained within the data repository 112 can be dynamic and can change periodically (e.g., daily or every millisecond), via an input from a user, via information from a sensor 104, via inputs from subcomponents of the data processing system 102 (e.g., load profile selector 106 or vehicle detector 110), or via an external update to the system 100, for example. Information in the data repository 112 can be stored in any kind of memory, such as a cloud or hard drive. The data repository 112 can include, for example, random access memory (RAM), dynamic random access memory (DRAM), static random access memory (SRAM), error-correcting code (ECC), read only memory (ROM), programmable read only memory (PROM), or electrically erasable read only memory (EEPROM). The data repository 112 can be accessed at any time and by any component of system 100. For example, the data repository 112 can be accessed by the system 100 at least periodically, in response to a change in the vehicle characteristic 114 detected by the vehicle detector 110, in response to the load profile selector 106 selecting a force profile 116, in response to a measurement transmitted by the sensor 104, or in a response to a connection of the cable 122 to a charge port 126 of a vehicle 405.

The vehicle characteristic 114 can refer to or include any detectable parameter of a vehicle, such as at least vehicle make, model, location, orientation, color, height, temperature, charge port type or impediments. For example, a vehicle characteristic can include whether the vehicle was backed into a charging location (e.g., a rear portion 440 of a vehicle 405 is closest to a vehicle charger 118) or was pulled in front-facing (e.g., a front portion 430 of a vehicle 405 is closest to a vehicle charger 118). A characteristic can include a location of a charge port of a vehicle. For example, a characteristic can include that a charge port (e.g., charge port 126 described herein) is located 8′ from a vehicle charger 118. The vehicle characteristic 114 can include an image of a vehicle, such as for image recognition. The vehicle characteristic 114 can be a data structure or list and can include one or more parameters as listed herein. For example, a vehicle characteristic 114 can include information pertaining to both the make and orientation of a vehicle, or can include information pertaining to the orientation, type of charge port, and type of vehicle.

The force profile 116 can be any model or data structure associated with characteristics of releasing a cable 122, such as a force, angle, gauge, weight, tension, or length of the cable 122. The force profile 116 can include one or more amounts of force which maps to lengths of cable 122 dispensed. The force profile 116 can relate different characteristics of a cable 122 to each other. For example, the force profile 116 can include information relating to the weight of a cable 122 as related to the cable's gauge and length. The force profile 116 can include a look up table including one or more characteristics of releasing a cable 122. The force profile 116 can be trained or added to with machine learning. For example, the force profile 116 can iteratively accept inputs from an environment (e.g., surrounding the components of FIG. 1) to create or change a database of the force profile 116. Inputs can include a force being exerted on the cable 122, a detection of a connection of the cable 122 to the charge port 126 of a vehicle 405, a detection of a completion of charging of the vehicle 405, or a vehicle characteristic 114. For example, responsive to an unknown (e.g., unrecognized within the force profile 116 or the vehicle characteristic 114) vehicle, the force profile 116 can store within a data structure a length of cable 122 to reach the charge port 126 given the orientation of the unknown vehicle and the vehicle itself. The force profile 116 can include information pertaining to the angle of the cable 122. The force profile 116 can relate a force to dispense the cable to an angle of dispensation of the cable 122. An angle of dispensation of the cable 122 can refer to the angle between the cable 122 and the vehicle charger 118 as the cable is pulled from the vehicle charger 118. For example, the amount of force with which to dispense the cable 122 can be modified responsive to at least the angle with which the cable 122 is dispensed and the length of the cable 122 that is dispensed.

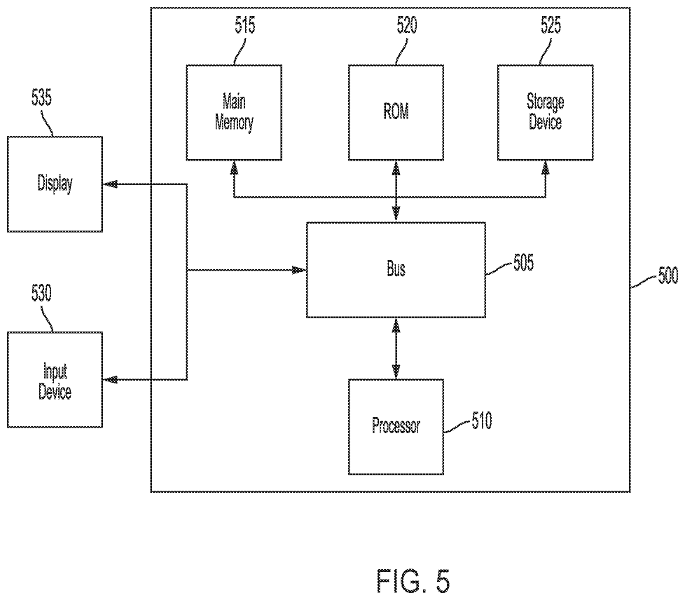

The data processing system 102 can interface with, communicate with, or otherwise receive or provide information with one or more of the sensor 104, vehicle 405, or vehicle charger 118. The data processing system 102 can include at least one logic device such as a computing device having a processor to communicate via a network. The data processing system 102 can include at least one computation resource, server, processor or memory. For example, the data processing system 102 can include a plurality of computation resources or processors, such as those described with reference to FIG. 5.

The load profile selector 106, controller 108, and vehicle detector 110 can each include at least one processing unit or other logic device such as a programmable logic array engine, or module configured to communicate with the data repository 112 or database. The load profile selector 106, controller 108, and vehicle detector 110 can be separate components, a single component, or part of the data processing system 102. The system and its components, such as a data processing system 102, can include hardware elements, such as one or more processors, logic devices, or circuits.

The data processing system 102 can store, transmit, receive, or display information that can facilitate controlling the speed or force of the dispensation of the cable 122. The data processing system 102 can communicate with internal subcomponents (described herein) or external components of the vehicle 405 or the charger 118 (e.g., a charge port 126 or an actuator 124). The data processing system 102 can, for example, store data about the system in data repository 112. The data processing system 102 can, for example, transmit information received by sensor 104 to the vehicle detector 110. Transmittal by the data processing system 102 can occur by a hardwire connection (e.g., the cable 122, copper wire, or fiber optics) or via a wireless connection (e.g., WiFi, Bluetooth, local area network (LAN)). The data processing system 102 can include a network of subcomponents (e.g., controller 108, load profile selector 106, vehicle detector 110, or data repository 112) which communicate with each other as described herein. The data processing system 102 can be coupled with a memory (e.g., data repository 112). The data processing system 102 can be physically located within the vehicle charger 118 or can be located remotely from vehicle charger 118 and accessed by an external computing device via a server 142 over a network 101.

The data processing system 102 can communicate with the vehicle 405, the vehicle charger 118, or an external computing device with a server 142 via a network 101. The server 142 can provide one or more functions or otherwise facilitate controlling the system 100. The server 142 can include one or many of, for example, a database, an application manager, a gateway server, a VPN, a firewall, a file server or a computer. The server 142 may be referred to as a remote machine or a node. The server 142 can be configured to perform function for the network 101, the charger 118, or the data processing system 102. For example, the charger 118 can interface with the server 142 to receive commands from the data processing system 102. The server can be located within the charger 118, or in a location remote to the charger 118 (e.g., a remote server in a database warehouse, a remote client device). The server 142 can operate according to one or more types of operating systems (e.g., WINDOWS XT, Unix, Linus, MacOS). The server can coordinate and provide functions for the data processing system 102. For example the server can be configured to perform functions for the controller 108, the vehicle detector 110, or the load profile selector 106. The server can operate or include any of the systems of FIG. 5.

The network 101 can include any kind of communications link, cables, transmitters, receivers, transceiver, logic circuit, communication chip, communication network (e.g. a local area network (“LAN”), a wide area network (“WAN”), or an inter-network (the internet) cellular network (e.g., 3G, 4G, or 5G)), configured to allow or facilitate communication, transmission, reception, or connection with the components of the system and with outside systems. The network 101 can be a private network or a public network. The network 101 can enable communication with the data processing system 102 and a vehicle charger 118, a vehicle 405, or the server 142.

The sensor 104 can include one or more sensors. The sensor 104 can include any type of sensor designed, constructed or operational to facilitate detection of a vehicle characteristic 114 or the vehicle charger 118. The sensors 104 can be dispersed internally or externally to a vehicle charger 118 or the data processing system 102. The sensors 104 can include proximity sensors, such as a capacitive proximity sensor, an inductive proximity sensor, or an ultrasonic proximity sensor. For example, a sensor 104 can detect the distance from a vehicle 405 to a vehicle charger 118. The sensors 104 can include motion sensors, such as passive infrared (PIR) sensors or microwave motion sensors. For example, a motion sensor can detect a car (such as vehicle 405) entering or exiting a location such as a parking spot. The sensors 104 can include a camera for image recognition. For example, the camera sensor 104 can take a photo or a video of a vehicle 405 for determination of characteristics 114 of the vehicle 405. The sensors 104 can include force sensors, such as a piezoresistive pressure sensor or strain gauge. For example, force sensors can measure the force or weight of the cable 122.

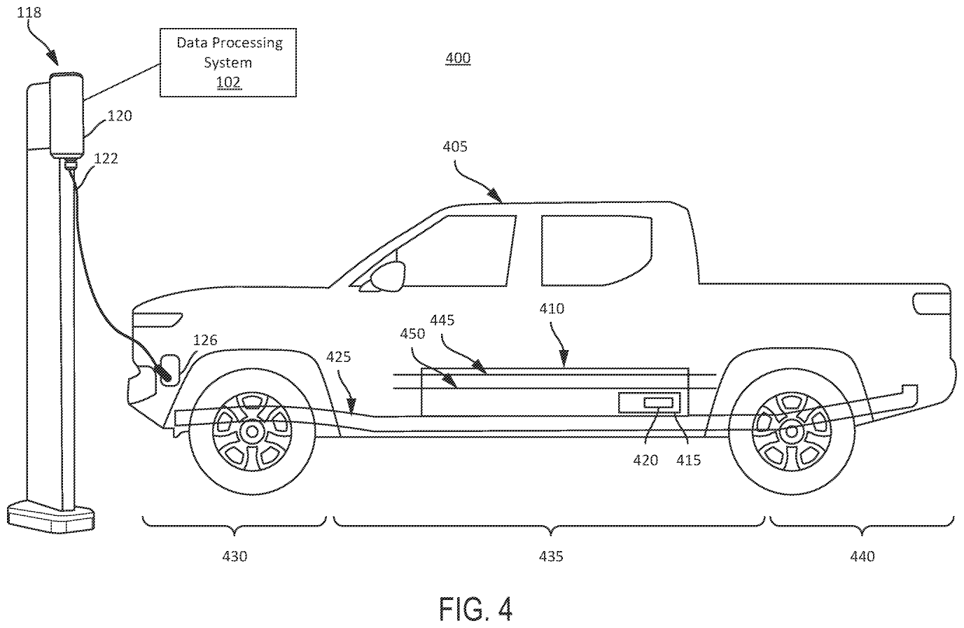

The vehicle 405 (e.g., vehicle 405 depicted in FIG. 4) can be any type of vehicle such as a truck, delivery van, or passenger vehicle. The vehicle 405 can be an electric vehicle. The vehicle 405 can include a charge port 126. The charge port 126 can be any input on or in the vehicle 405 to accept a power source for charging the vehicle 405. For example, the charge port 126 can be a male or female receptacle for accepting a cable 122 with a plug to recharge electric batteries 415 of the vehicle 405. For example, the charge port 126 can include a connection point configured to receive an SAE J1772 connector or a SAE CCS1 type connector. The charge port 126 can include a transmitter/receiver to transmit or receive (e.g., via a handshake protocol or carrier signal over the cable 122) confirmation of a connection between the vehicle charger 118 and the charge port 126 via a cable 122. The charge port 126 can accept energy in the form of at least electric power. For example, the charge port 126 can accept alternating current (AC), direct current (DC), pulse width modulation (PWM), or another form of electric signal frequency. The charge port 126 can accept any current, voltage, or wattage in accordance with the vehicle 405. The charge port 126 can be located anywhere on the vehicle and can be any shape. For example, the charge port 126 can be circular or square. For example, the charge port 126 can be located on a front portion 430, a body portion 435, or a rear portion 440 of the vehicle 405. The charge port 126 can include a cap to cover a connection point of the charge port 126. The charge port 126 can include screw threads, a magnetic strip, or a securing mechanism for securing the plug of the cable 122 to the charge port 126 during a charging session. The charge port 126 and the cable 122 can make at least one positive, negative, ground, or data communication connection with the vehicle 405 between the vehicle charger 118 and the vehicle 405 or a battery pack 410, batteries 415 or battery modules 415, or battery cells 420.

The vehicle charger 118 can provide power to the vehicle 405 via at least one cable 122. The cable 122 can be contained or at least partially contained, stored, or housed within the dispenser 120. The release of the cable 122 can operated by actuator 124. The cable 122 can be a harness, conductor, connector, at least one wire, bus bar, or other component that can provide the power to the vehicle 405. The cable 122 can be any gauge, strain, or ampacity. The cable 122 can contain any number of conductors. The cable 122 can be shielded. The cable 122 can have any type of insulation, such as polytetrafluoroethylene (PTFE), polyvinyl chloride (PVC), or polyethylene (PV). The cable 122 can be wound, spooled, folded, or pleated for storage within the dispenser 120. The cable 122 can transmit at least power or signals.

The vehicle charger 118 (e.g. “charger 118”) can include a plug or other device coupled with the cable 122 that makes electrical connections with the charge port 126 of the vehicle 405. The charge port 126 and the cable 122 can make at least one positive, negative, ground, or data communication connection with a vehicle 405 between the vehicle charger 118 and the vehicle 405 or a battery pack 410, batteries 415 or battery modules 415, or battery cells 420. The cable 122 can convey power between the vehicle 405 and the charger 118 (e.g., the charger 118 can deliver power to the vehicle 405, or the vehicle 405 can deliver power to the charger 118). The charger 118 can convey power via the cable 122 and the charge port 126 to the vehicle 405 to charge the battery pack 410, batteries 415 or battery modules 415, or battery cells 420. The charger 118 can be powered by at least an external battery bank, an electric grid system, or distributed generation (such as photovoltaics on the charger 118). The vehicle charger 118 can include the dispenser 120 and the actuator 124. The vehicle charger 118 can be ground-mounted, overhead mounted, or wall-mounted.

The dispenser 120 can be any compartment, spool, or spring for containing the cable 122. The dispenser 120 can release, dispense, or retract the cable 122. The dispenser 120 can include a clamp that can apply an amount of force via friction to the cable 122. For example, the dispenser 120 can apply an amount of force to the cable 122 via a clamp responsive to a second applied force on the cable 122, an indication that the cable 122 has been connected to the charge port 126, or upon reaching the end of the cable 122 within the dispenser 120. The dispenser 120 can be coupled with an actuator 124. The actuator 124 can be any motor, spring, or apparatus for deployment of the cable 122 via the dispenser 120. For example, the actuator 124 can be a motor which unwinds a spool of the cable 122 within the dispenser 120. For example, the actuator 124 can be an adjustable spring. The actuator 124 can be powered by the charger 118. The actuator 124 can receive an instruction for operation from the controller 108.

In an illustrative example, the data processing system 102 can transmit a measurement by a sensor 104 to the vehicle detector 110. The vehicle detector 110 can subsequently identify a vehicle characteristic 114 to provide to the load profile selector 106. The load profile selector 106 can select a force profile 116 based on at least a vehicle characteristic 114. The load profile selector 106 can relay the selected force profile 116 to the controller 108, which can in turn send an instruction to the actuator 124 of the vehicle charger 118 to release a length of cable 122 from the dispenser 120 at least at a force denoted in the selected force profile 116. Responsive to a connection of the cable 122 to the charge port 126, the actuator 124 can cease providing tension so as to prevent a force pulling at the charge port 126 of the vehicle 405. Subsequent to the removal of the cable 122 from the charge port 126, the vehicle detector 110 can detect a second vehicle characteristic 114 indicating that the cable 122 has been removed from the charge port 126, and can subsequently (through the load profile selector 106 and the controller 108 as described herein) send an instruction to the actuator 124 to retract the cable 122 back into the dispenser 120 at a predetermined speed. The predetermined speed can be contained within the force profile 116.

The data processing system 102 can include a vehicle detector 110 designed, constructed and operational to receive, identify, obtain, or otherwise access vehicle characteristics 114. The vehicle detector 110 can be any combination of hardware and software for collecting, storing, processing, identifying or receiving information or data of a vehicle 405 corresponding to a vehicle characteristic 114. The vehicle characteristics 114 can include, for example, orientation, charge capacity, charge port connection status (e.g., whether a cable 122 is connected to the charge port 126 or not), height of the vehicle 405, orientation of the vehicle 405, type of the vehicle, make or model of the vehicle 405, or temperature of the vehicle 405. The vehicle detector 110 can accept inputs from the one or more sensors 104 to detect a vehicle characteristic 114. For example, the vehicle detector 110 can receive information from a sensor 104 (e.g., proximity sensor, range sensor, or transducer) indicating a distance from the vehicle charger 118 to the vehicle 405. For example, the vehicle detector 110 can receive information from a sensor 104 indicating the type of charge port 126 of a vehicle 405.

The vehicle detector 110 can update the vehicle characteristics 114 through machine learning, a user input (such as on an input device 530), or an external computing system. For example, the vehicle detector 110 can add or delete vehicle characteristics 114. For example, responsive to the vehicle detector 110 making a detection of an unknown (e.g., uncatalogued in data repository 112) vehicle characteristic 114, the vehicle detector 110 can update one or more vehicle characteristics 114 within the data repository 112.

The vehicle detector 110 can include image recognition technology. Image recognition technology can include hardware or software configured to take an image or a video and identify, based on that image or video, a vehicle 405 and its characteristics 114. For example, the vehicle detector 110 can utilize a camera (e.g., a camera type of sensor 104) to capture an image of a vehicle 405 parked at a vehicle charger 118 and identify, from the image, a characteristic 114 of the vehicle 405 such as make, model, orientation, or color. For example, a type of charge port 126 of a vehicle 405 can be identified by image recognition performed by the vehicle detector 110. For example, impediments (e.g., hitch racks, persons, bicycles, vehicle attachments) to the charger 118 or the vehicle 405 can be identified by the vehicle detector 110 via image recognition. The vehicle detector 110 can transmit one or more vehicle characteristics 114 to the load profile selector 106.

The load profile selector 106 can be designed, constructed and operational to select, identify, determine or choose a force profile 116. The load profile selector 106 can select the force profile 116 based at least on a vehicle characteristic 114. The load profile selector 106 can be any combination of hardware and software configured to determine, responsive to an identification of one or more vehicle characteristics 114 by the vehicle detector 110, a corresponding force profile 116. The load profile selector 106 can determine an amount of force to apply to the cable 122 or a length of the cable 122 to couple the vehicle charger 118 with the vehicle 405 by choosing a force profile 116 based at least on a vehicle characteristic 114. Responsive to this characteristic, the load profile selector 106 can perform a look up (e.g., search, parse) through the force profiles 116 for a force profile 116 corresponding to the identified vehicle characteristics 114. The corresponding force profile 116 can contain data related to a force, length, or angle of the cable 122 to deploy, responsive to the vehicle characteristic 114.

The load profile selector 106 can iteratively calculate, determine, or look up at least a corresponding force or length in real time as the cable 122 is pulled from the dispenser 120. For example, as the cable 122 is pulled from the dispenser 120, the weight of the released cable 122 can increase. The load profile selector 106 can, in response to the increased cable weight, change the amount of force to apply to the cable 122 to provide an easier load for the user to bear. For example, the load profile selector 106 can dynamically change the force or length of the cable 122 to be deployed. For example, the load profile selector 106 can adjust the length of the cable 122 responsive to an indication that the cable 122 has not yet been connected with the charge port 126. For example, the load profile selector 106 can set an amount of force for the cable 122 based on the length of the cable 122, determined from a look up in the data repository 112. The load profile selector 106 can dynamically relay instructions to the controller 108 to control the force or length of cable 122.

TABLE 1
Illustrative force profile relating vehicle characteristics to cable lengths and forces

| | Type | | | | | | | | | | | |
|---|---|---|---|---|---|---|---|---|---|---|---|---|
| | Example: Type A | | | | | | Example: Type B | | | | | |
| | Orientation | | | | | | | | | | | |
| | Back In | | | Forward In | | | Back In | | | Forward In | | |
| Distance to | 10-14 | 14-18 | 18-22 | 4-7 | 7-10 | 10-14 | 10-14 | 14-18 | 18-22 | 4-7 | 7-10 | 10-14 |
| Charge port (ft) | | | | | | | | | | | | |
| Corresponding | 16′/ | 20′/ | 24′/ | 8′/ | 12′/ | 16′/ | 16′/ | 20′/ | 24′/ | 16′/ | 20′/ | 24′/ |
| charge cable | 5 lb | 7 lb | 9 lb | 1 lb | 3 lb | 5 lb | 5 lb | 7 lb | 9 lb | 5 lb | 7 lb | 9 lb |
| Length/Weight | | | | | | | | | | | | |

Table 1 shows an illustrative force profile relating vehicle characteristics to cable lengths and forces. Table 1 is meant to be exemplary and is in no way to be construed as restrictive or inclusive of all possible vehicle characteristics or force profile attributes. Table 1 relates the type of vehicle (e.g., Type B or Type A) to the corresponding charge cable (e.g., cable 122) length and weight as related to the vehicle's distance to charge port (e.g., the charge port 126) and orientation.

The controller 108 can be designed, constructed and operational to manage, control, modify, or otherwise influence at least the actuator 124, cable 122, or dispenser 120. The controller 108 can be any combination of hardware and software to receive an indication of at least force, length, or speed from the load profile selector 106 and apply the indication to at least the actuator 124 of the vehicle charger 118 to release the cable 122 at the indicated force, length, or speed. The controller 108 can actuate, initiate, or control the actuator 124 or the dispenser 120. For example, controlling the dispenser 120 can include providing an instruction for the dispenser 120 to unspool a spool of cable 122 at a speed determined by the force profile 116. For example, the controller 108 can provide an instruction to unspool a cable 122 at a rate of 0.5″ per second. The controller 108 can provide an instruction to cause the dispenser 120 to apply the amount of force (determined by the load profile selector 106 and the selected force profile 116) to the cable 122. For example, the controller 108 can provide an instruction to cause the dispenser 120 to apply a force of 3 pounds to the cable 122. The force, speed, or length initiated by the controller 108 can change dynamically. For example, as the length of the cable 122 is pulled from the dispenser 120, the force acted upon the cable by the dispenser 120 may increase proportional to the weight of the cable 122 being withdrawn. For example, the force may constantly increment or decrement (e.g., 1 ounce/second) or the force may increment or decrement dynamically (e.g., in a nonlinear relation to the force being exerted on the cable 122 by the user).

Thus, by detecting a vehicle characteristic 114, the data processing system 102 can determine and select an amount of force, length of cable, or speed with which to withdraw the cable 122 from the dispenser 120 and can release or retract the cable 122 according to the determined force, length of cable, or speed. The system 100 can improve a user charging experience through ease of automatic cable management and reduction manual labor through cable weight.

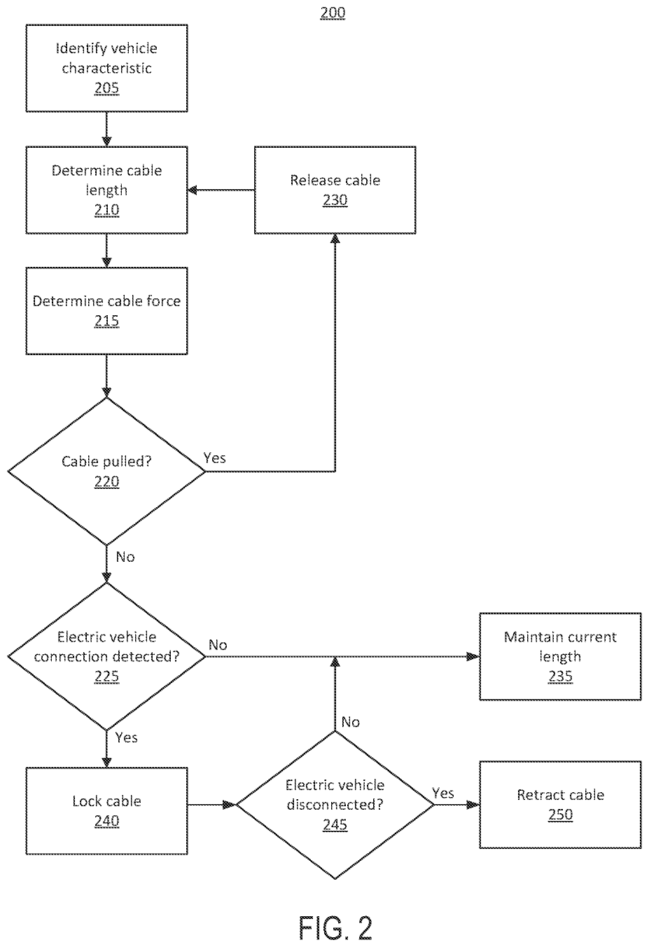

FIG. 2 depicts an example method 200 for controlling a cable of a charger. The method 200 can be performed by one or more systems of components depicted in FIG. 1, FIG. 4, or FIG. 5, including, for example, a data processing system. At ACT 205, the data processing system can identify a vehicle characteristic. A vehicle characteristic can be the vehicle characteristic 114. A vehicle characteristic 114 can be identified by the vehicle detector 110. The vehicle detector 110, as described herein, can be coupled with one or more sensors 104 to detect a vehicle characteristic 114. The vehicle characteristic 114 can include a characteristic of a vehicle 405, such as a make, model, color, height, or a location of a charge port 126. Subsequent to detection of a vehicle characteristic 114, the flow can proceed to ACT 210.

At ACT 210, the data processing system can determine a cable length. A cable 122 can have a length which can correspond to the length to reach from the vehicle charger 118 to the charge port 126. A cable length can be determined based on at least the vehicle characteristic 114. The cable length can be determined by the load profile selector 106. For example, the load profile selector 106 can determine the cable 122 length by performing a look up in a database including force profiles 116. The force profile 116 can include as a part of its data structure or model, a length of a cable 122 which corresponds to a vehicle characteristic 114.

At ACT 215, the data processing system can determine a cable force to apply. A cable force can be any force, pressure, weight, or tension applied or to be applied to cable 122. A cable force can correspond to at least a weight of the cable 122, a weight per length of the cable 122, or an outside force on the cable (e.g., a user pulling the cable 122). A cable force can be contained in the data structure or model of force profile 116. The load profile selector 106 can determine, from a length of the cable 122 or a force profile 116, a force to apply to the cable 122. A force to apply to the cable can correspond to a force to lessen or ease the pulling of the cable 122 from the dispenser 120, to retract the cable 122 back into the dispenser, or another force.

At ACT 220, the data processing system can determine if the cable has been pulled. The load profile selector 106 can be coupled with one or more sensors 104. For example, the load profile selector 106 can determine if a first or a second force has been exerted upon the cable 122. The load profile selector 106 can make a determination of if the cable 122 has been pulled. The cable 122 can be pulled, for example, by a user to extend the cable 122 to the charge port 126 of the vehicle 405 to enable charging of the vehicle 405. For example, if the cable 122 has been pulled, the method 200 can proceed to ACT 230, wherein the cable is released. If the cable 122 has not been pulled, the method 200 can proceed to ACT 225.

At ACT 230, the cable is released. The cable 122 can be released responsive to at least the cable 122 being pulled as described in act 220. Releasing the cable 122 can refer to increasing the amount of length of the cable 122 being let out by the dispenser 120. Subsequent to the release of the cable 122, the method 200 can proceed to ACT 210, wherein the data processing system can determine the cable length. In this manner, the cable length and force can be iteratively calculated as the cable 122 is pulled from the dispenser 120. Thus, the amount of force applied to the cable 122 can be continuously calculated and adjusted to provide for a dynamic force to be applied to the cable 122 as the weight and length of the cable 122 adjusts.

At ACT 225, the data processing system can detect the electric vehicle connection. One or more sensors 104 coupled with the data processing system 102 or the vehicle charger 118 can determine or detect the electric vehicle (e.g., vehicle 405) connection. For example, the charge port 126 of the vehicle 405 can send an indication, either wirelessly (e.g., over BlueTooth, LAN, etc.) or via a carrier signal on the cable 122 to the data processing system 102 that it has been connected to the cable 122 or a plug of the cable 122. The cable 122 can send or carry an indication to the data processing system 102 that it has made connection with the charge port 126 of the vehicle 405.

If no electric vehicle (e.g., vehicle 405) connection is detected and the cable 122 is not being pulled, the cable 122 can maintain its current length as shown at ACT 235. For example, if a user becomes distracted and ceases pulling the cable, the cable can remain at its present length. As an example (not pictured), the cable 122 can maintain its current length until a threshold amount of time has passed, when then the cable 122 can retract. For example, if a user abandons the cable 122, the cable can, after an established period of time, retract into the dispenser 120.

At ACT 240, the cable is locked. The cable 122 can be locked responsive to a detection of an electric vehicle connection. Locking the cable 122 can refer to disabling pulling more cable 122 from the dispenser 120. For example, the cable can be locked by a clamp coupled with the dispenser 120. For example, the clamp can hold the cable 122 at its current length in the dispenser 120 such that additional pulling of the cable 122 will not result in additional length of the cable 122. The clamp can lock the cable 122 by exerting force on the cable 122. The force on the cable 122 can be a friction force. The cable 122 can be locked by an indication from the controller 108 responsive to a determination that the charge port 126 of the vehicle 405 can been connected to the cable 122. The cable 122 can be locked responsive to a determination that power is flowing through the cable 122.

At ACT 245, the data processing system can determine if the electric vehicle 405 is disconnected. Disconnected can refer to the cable 122 no longer being connected to the charge port 126 of the vehicle 405. The vehicle 405 can be disconnected responsive to completion of vehicle 405 charging, or to a removal of a plug of the cable 122 from the charge port 126. The disconnection can be sensed by one or more sensors 104 coupled with the vehicle charger 118 or the data processing system 102. If the electric vehicle 405 is not disconnected, the method 200 can proceed to ACT 235, wherein the current length of the cable 122 is maintained. If the electric vehicle 405 is disconnected, the method 200 can proceed to ACT 250, wherein the cable is retracted.

At ACT 250, the cable retracts. The cable 122 can be retracted by one of or a combination of at least the dispenser 120, the actuator 124, or the controller 108. The cable 122 can be retracted responsive to an indication that the vehicle 405 has been disconnected from the cable 122. Retracting the cable 122 can refer to reducing the length of the cable by absorbing it into the vehicle charger 118. The length of the cable 122 can be reduced, for example, by re-spooling a spool of the dispenser 120 or retracting a spring of the dispenser 120. Retracting the cable 122 can enable the cable 122 to return to the dispenser 120. For example, retracting the cable 122 can be done automatically upon disconnection of the cable 122 from the charge port 126, upon replacing the cable within the vehicle charger 118, or upon a user indication via a user input, such as through an input device 530. For example, a user can drop the cable 122 on the ground, and the dispenser 120, the actuator 124, or the controller 108 can retract the cable back into the dispenser 120. Retraction can be controlled by the controller 108. The controller 108 can send an indication to the actuator 124 or the dispenser 120 to enable retraction of the cable 122.

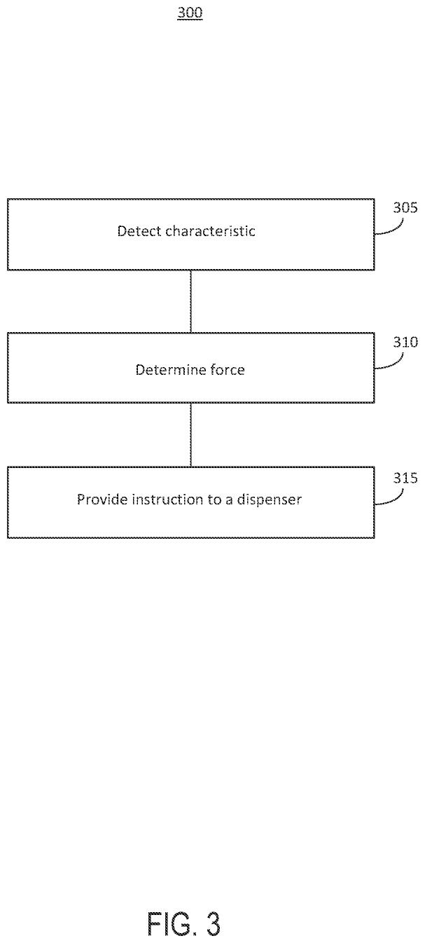

FIG. 3 depicts an example method 300 for applying tension to a cable. The method 300 depicted herein can include more or fewer acts than described and can be enabled or acted out by the components of FIG. 1, FIG. 4, or FIG. 5. The method includes ACT 305, wherein the data processing system detects a characteristic of a vehicle. A characteristic can be like vehicle characteristics 114. A characteristic can be measured by one or more sensors, such as sensors 104. A characteristic can include at least a type of a vehicle (e.g., vehicle 405) or an orientation of the vehicle (e.g., vehicle 405). For example, a characteristic can include that the vehicle 405 is parked with a front portion 430 facing the charger 118. A characteristic can include an identification of a type of vehicle. A type of vehicle can include at least one of the vehicle's make, model, year, color, or body type (e.g., truck, sedan, SUV). For example, a type of vehicle can include a Rivian (e.g., make) RIS (e.g., model).

The characteristic (e.g., the vehicle characteristics 114) can be detected by one or more processors coupled with memory. One or more processors coupled with memory can include the vehicle detector 110, as described herein. The vehicle detector 110 can be coupled with a sensor 104. The vehicle detector 110 can detect, with the sensors 104, a vehicle characteristic 114 as described herein. The vehicle detector 110 can detect more than one vehicle characteristic 114. The vehicle detector 110 can store vehicle characteristics 114 in a memory, such as data repository 112. For example, the vehicle detector 110 can detect a make of a vehicle 405 and can store the make of the vehicle 405 in the data repository 112 as a vehicle characteristic 114.

At ACT 310, the data processing system can determine force. Determining force can refer to determining a force to apply to or remove from a cable (e.g., cable 122). The force can be a first force. For example, determining force can be responsive to a detection of a vehicle characteristic 114. One or more processors (e.g., the load profile selector 106) can determine the force. For example, the load profile selector 106 can assess a vehicle characteristic 114 to make a determination of which force profile 116 to apply to the cable 122. Furthermore, the load profile selector 106 can determine, based at least in part on a characteristic (e.g., vehicle characteristic 114) a length of the cable 122 to couple the vehicle charger 118 with the vehicle 405. For example, the load profile selector 106 can select a force profile 116 which corresponds to a vehicle characteristic 114. For example, the vehicle characteristic 114 can indicate that a vehicle 405 has been backed in (e.g., a rear portion 440 is nearest to the vehicle charger 118) and can indicate a distance from the charge port 126 of the backed in vehicle 405 to the vehicle charger 118. Responsive to this characteristic 114, the load profile selector 106 can select a force profile 116 which corresponds to the vehicle characteristic 114 indicated. The selected force profile 116 can include a length of cable 122 to reach from the charge port 126 to the vehicle charger 118. The selected force profile 116 can include a force (e.g., in pounds, newtons) which, when enacted, can enable the user to pull the cable 122 towards the charge port 126. The force can be at least proportional to the weight of the cable 122 at the length indicated in the force profile 116, or proportional to the pulling force enacted by the user.

The load profile selector 106 can identify and measure forces being applied to the cable 122. The load profile selector 106 can be coupled with one or more sensors 104. For example, the load profile selector 106 can identify, with sensors 104, a second amount of force with which the cable 122 is pulled from the dispenser 120. A second amount of force can be, for example, a sudden jerk of the cable 122 or a pulling of the cable 122 from the dispenser 120 by a user. For example, if the second amount of force differs from the first amount of force (as selected by the load profile selector 106 from a force profile 116), the load profile selector 106 can increase the first amount of force (e.g., the force applied to the cable) to reduce the second amount of force. For example, if the load profile selector 106 applies a first amount of force to the cable 122 which is subsequently exceeded by a second amount of force, the load profile selector 106 can indicate a different amount of force to apply to the cable 122 to reduce the second force.

At ACT 315, the data processing system can provide instructions to a dispenser. Instructions can be provided to a dispenser (e.g., dispenser 120) by one or more processors (e.g., controller 108). An instruction can cause the dispenser 120 to apply an amount of force to the cable 122. For example, an instruction can control the actuator 124. The actuator 124 can be coupled with the dispenser 120 and, responsive to receiving instruction from the controller 108, enable the dispenser 120 to apply an amount of force (such as determined by load profile selector 106 at ACT 310) to the cable 122. The instruction can include applying at least one of a first force, a second force, a static amount of force, or a dynamic amount of force, as indicated by the load profile selector 106 or the force profile 116.

FIG. 4 depicts an example vehicle and a charger. The vehicle 405 can be coupled with the charger 118. Vehicle 405 can be installed with at least one battery pack 410. Vehicle 405 can be an electric vehicle. Electric vehicles 405 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 410 can also be used as an energy storage system to power a building, such as a residential home or commercial building. Electric vehicles 405 can be fully electric or partially electric (e.g., plug-in hybrid) and further, electric vehicles 405 can be fully autonomous, partially autonomous, or unmanned. Electric vehicles 405 can also be human operated or non-autonomous. Electric vehicles 405 such as electric trucks or automobiles can include on-board battery packs 410, batteries 415 or battery modules 415, or battery cells 420 to power the electric vehicles. The electric vehicle 405 can include a chassis 425 (e.g., a frame, internal frame, or support structure). The chassis 425 can support various components of the electric vehicle 405. The chassis 425 can span a front portion 430 (e.g., a hood or bonnet portion), a body portion 435, and a rear portion 440 (e.g., a trunk, payload, or boot portion) of the electric vehicle 405. The battery pack 410 can be installed or placed within the electric vehicle 405. For example, the battery pack 410 can be installed on the chassis 425 of the electric vehicle 405 within one or more of the front portion 430, the body portion 435, or the rear portion 440. The battery pack 410 can include or connect with at least one busbar, e.g., a current collector element. For example, the first busbar 445 and the second busbar 450 can include electrically conductive material to connect or otherwise electrically couple the battery 415, the battery modules 415, or the battery cells 420 with other electrical components of the electric vehicle 405 to provide electrical power to various systems or components of the electric vehicle 405.

For example, the battery cell 420 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 420 to separate the anode and cathode from each other and to facilitate transfer of lithium ions between the anode and cathode. It should be noted that battery cell 420 can also take the form of a solid state battery cell developed using solid electrodes and solid electrolytes.

FIG. 4 further depicts the vehicle charger 118, the dispenser 120, the cable 122, the charge port 126, and the data processing system 102. It should be noted that the display of charger 118 is exemplary, and that the charger 118 can take any form, such as a ground mounted charger, overhead mounted charger, or wall mounted charger, for example. Furthermore, the charge port 126 of the vehicle 405 is also exemplary. The charge port 126 can be located on any location of the vehicle 405, such as the front portion 430, the body portion 435, or the rear portion 440.

FIG. 5 depicts an example block diagram of an example computer system 500. The computer system or computing device 500 can include or be used to implement a data processing system or its components. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random access memory (RAM) or other dynamic storage device, coupled to the bus 505 for storing information, and instructions to be executed by the processor 510. The main memory 515 can be used for storing information during execution of instructions by the processor 510. The computing system 500 may further include at least one read only memory (ROM) 520 or other static storage device coupled to the bus 505 for storing static information and instructions for the processor 510. A storage device 525, such as a solid state device, magnetic disk or optical disk, can be coupled to the bus 505 to persistently store information and instructions.

The computing system 500 may be coupled via the bus 505 to a display 535, such as a liquid crystal display, or active matrix display, for displaying information to a user such as a driver of the electric vehicle 405 or other end user. An input device 530, such as a keyboard or voice interface may be coupled to the bus 505 for communicating information and commands to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a dispenser of a vehicle charger, the dispenser configured to provide a cable; and
one or more processors communicatively coupled with memory and the dispenser, the one or more processors configured to:
detect a characteristic of a vehicle;
determine, based at least in part on the characteristic of the vehicle, an amount of force to apply to the cable; and
provide an instruction to cause the dispenser to apply the amount of force to the cable.

2. The system of claim 1, comprising the one or more processors to:
detect, via a sensor, the characteristic comprising at least one of a type of the vehicle or an orientation of the vehicle.

3. The system of claim 1, comprising the one or more processors to:
determine, based at least in part on the characteristic, a length of the cable to couple the vehicle charger with the vehicle; and
determine the amount of force based at least in part on the length of the cable.

4. The system of claim 1, comprising the one or more processors to:
perform a lookup in a data repository with the characteristic to determine a length of the cable to couple the vehicle charger with the vehicle; and
set the amount of force based on the length of the cable.

5. The system of claim 1, comprising:
the one or more processors to determine, based at least in part on the characteristic and via a model trained with machine learning, the amount of force.

6. The system of claim 1, comprising the one or more processors to:
identify a force profile comprising a plurality of amounts of force that map to lengths of cable dispensed.

7. The system of claim 1, comprising the one or more processors to:
determine the amount of force with which to dispense the cable responsive to an indication to dispense the cable for a charging session with the vehicle.

8. The system of claim 1, comprising:
the one or more processors to modify the amount of force responsive to an angle with which the cable is dispensed and a length of the cable that is dispensed.

9. The system of claim 1, comprising the one or more processors to:
identify, via a sensor, a second amount of force with which the cable is pulled from the dispenser; and
increase the amount of force applied to the cable to reduce the second amount of force.

10. The system of claim 1, wherein the dispenser comprises:
a spool controlled by a motor configured to apply the amount of force to the cable.

11. The system of claim 1, wherein the dispenser comprises:
a clamp configured to apply the amount of force via friction to the cable.

12. The system of claim 1, comprising the one or more processors to:
detect that a plug of the cable is connected to the vehicle; and
lock a length of the cable responsive to the detection that the cable is connected to the vehicle.

13. The system of claim 1, comprising the one or more processors to:
receive an indication to retract the cable; and
provide an instruction to cause the dispenser to retract the cable at a predetermined speed.

14. A method, comprising:
detecting, by one or more processors coupled with memory, a characteristic of a vehicle;
determining, by the one or more processors based at least in part on the characteristic of the vehicle, an amount of force to apply to a cable; and
providing, by the one or more processors, an instruction to cause a dispenser to apply the amount of force to the cable.

15. The method of claim 14, comprising:
detecting, by the one or more processors via a sensor, the characteristic comprising at least one of a type of the vehicle or an orientation of the vehicle.

16. The method of claim 14, comprising:
determining, by the one or more processors based at least in part on the characteristic, a length of the cable to couple the vehicle charger with the vehicle; and
determining, by the one or more processors, the amount of force based at least in part on the length of the cable.

17. The method of claim 14, comprising:
identifying, by the one or more processors via a sensor, a second amount of force with which the cable is pulled from the dispenser; and
increasing, by the one or more processors, the amount of force applied to the cable to reduce the second amount of force.

18. A vehicle charger, comprising:
a dispenser configured to provide a cable; and
one or more processors communicatively coupled with memory and the dispenser, the one or more processors configured to:
detect a characteristic of a vehicle;
determine, based at least in part on the characteristic of the vehicle, an amount of force to apply to the cable; and
provide an instruction to cause the dispenser to apply the amount of force to the cable.

19. The vehicle charger of claim 18, comprising:
the one or more processors to detect, via a sensor, the characteristic comprising at least one of a type of the vehicle or an orientation of the vehicle.

20. The vehicle charger of claim 18, comprising the one or more processors to:
determine, based at least in part on the characteristic, a length of the cable to couple the vehicle charger with the vehicle; and
determine the amount of force based at least in part on the length of the cable.
